(19) United States
(12) Patent Application Publication
(10) Pub. No.: US 2010/0299212 A1
(43) Pub. Date: Nov. 25, 2010

(54) SYSTEM AND METHOD FOR A COMMERCE WINDOW APPLICATION FOR COMPUTING DEVICES

(75) Inventors: WILL GRAYLIN, SAUGUS, MA (US); MICHAEL ARNER, BRIGHTON, MA (US)

Correspondence Address: AKC PATENTS, 215 GROVE ST., NEWTON, MA, 02466, US

(73) Assignee: ROAM DATA INC, Boston, MA (US)

(21) Appl. No.: 12/850,685

(22) Filed: Aug. 5, 2010

Related U.S. Application Data
(63) Continuation-in-part of application No. 12/198,944, filed on Aug. 27, 2008.
(60) Provisional application No. 61/291,807, filed on Dec. 31, 2009.

(51) Int. Cl. G06Q 30/00; G06F 21/20; G06F 15/16

(52) U.S. Cl. 705/14.66; 726/7; 709/217; 705/26.1; 705/26.7

(57) ABSTRACT

A commerce window system includes a consumer computing device, a commerce window gateway server and a plurality of merchants. The consumer computing device comprises a commerce application player executable by the consumer computing device. The commerce window gateway server comprises a commerce application and a secure payment application and the commerce window gateway server communicates with the consumer computing device via a first network connection. The plurality of merchants provide product offers to the consumer computing device via the commerce application and receive payments via the secure payment application. The commerce application comprises a plurality of commerce offer managers and each commerce offer manager is associated with a specific merchant and comprises a commerce offer application that presents product offers for sale by the specific merchant. A specific commerce offer application of a specific merchant is downloaded and executed by the commerce application player in the consumer computing device and displays product offers from the specific merchant in the consumer computing device. Each commerce offer manager further comprises an offer management application used to generate product offers by the specific merchant. Each product offer is associated with a product offer identifier and a specific merchant identifier.

### CROSS REFERENCE TO RELATED CO-PENDING APPLICATIONS

This application claims the benefit of U.S. provisional application Ser. No. 61/291,807 filed on Dec. 31, 2009 and entitled SYSTEM AND METHOD FOR A COMMERCE WINDOW APPLICATION FOR MOBILE DEVICES which is commonly assigned and the contents of which are expressly incorporated herein by reference.

This application is a continuation in part of U.S. application Ser. No. 12/198,944 filed on Aug. 27, 2008 and entitled SYSTEM AND METHOD FOR DEVELOPING RICH INTERNET APPLICATIONS FOR REMOTE COMPUTING DEVICES which is commonly assigned and the contents of which are expressly incorporated herein by reference.

### FIELD OF THE INVENTION

The present invention relates to a system and a method for a commerce window application for merchants to deliver commerce functionalities to consumers computing devices.

### BACKGROUND OF THE INVENTION

Merchant websites with shopping cart for commerce transactions represent “eCommerce 1.0” methodology, whereby a consumer uses a merchant's website (hosted by themselves or third parties) to enter order parameters (i.e., quantity, size, color), billing, shipping and payment information to complete a transaction. This means the consumer needs to leave the original website or application they were in, to enter a merchant's commerce site via a banner add or link, in order to complete the transaction.

Presently it is still very difficult for merchants or application developers or content providers or advertisers to deliver secure commerce capabilities within mobile applications. It is also very difficult to deliver a time sensitive and relevant product offer or request to a consumer's own mobile phone and then allow the consumer to conveniently pay for the product or request and complete the purchase transaction. Marketing firms may send text messages or multimedia messages with advertising or offers to a consumer's mobile phone, but completing the purchasing transaction on the spot on the mobile device is still very hard. Payment gateways that can process transactions for merchants generally do not deliver dynamic offers to a variety of mobile phones and do not securely make the transaction happen and do not complete the fulfillment request back to the merchants. Today, for many mobile shopping applications, the mobile consumer is re-directed with a URL-link to a merchant's website via the mobile device browser and then the consumer can go through the shopping process and checkout like any other web-customer. This process is usually cumbersome to go through, and the user experience on a browser is slow and many customers abandon the process before completing the transaction. Letting many merchants present offers to a mobile customer in a single mobile application that can be transacted upon is even harder. Today there are no intermediary services that can do that on behalf of merchants while providing a trusted point of service for the convenience of mobile consumers. For mobile application developers, building mobile applications that contain secure commerce capabilities is not easy, particularly if they want to complete transactions for merchants within their application, as they have to maintain PCI certification and PA DSS certification requirements to keep card holder information secure, and to be able to securely route the transactions to the payment processors, and provide purchase order back to merchant's fulfillment system. For consumers, forcing them to go to one mobile application storefront at a time, and setting up different payment methods for each mobile storefront is very inconvenient. A better method is needed for enabling commerce on mobile devices, and for delivering product offers and request directly to the consumer's mobile phone, while allowing the consumer to easily make the purchase.

Most traditional electronic transactions today are done via one of the following methods.
1. Traditional POS (point of sale) terminal retail transactions: where consumers can swipe their credit/debit cards or key the card information into the POS terminal held by the merchant with the merchant's own MID (merchant ID) embedded in the payment application on the POS terminal. The transaction is then electronically transferred for authorization and settlement by a payment processor/bank directly or via a payment gateway, and money is deposited to the merchant's account associated with that MID.
2. Traditional e-Commerce transactions: where users/consumers go to a merchant's website to shop, items are dropped into the “shopping cart” then user/consumer go to checkout/payment where by card information is entered and the ecommerce transaction is routed via an API through an ecommerce gateway or directly to a payment processor, and money is deposited to the merchant's account associated with that MID.
3. Traditional Mail Order Telephone Order (MOTO) transactions: where users provide credit card information via telephone or mail orders, and merchants authorize these payments with their payment processor from their headquarters remotely via card not present (CNP) transactions keyed in via virtual terminals or processed by batches electronically sent to the processors for the merchant on that merchant's MID.
4. Traditional Mobile Application Store transactions (like Apple, Get It Now Catalog by Verizon, or Aggregators, among others): where consumers see offers from a centralized location, and operator of the store collects the money and then settles with the merchants who are offering the digital content products such as applications, games, ringtones, that consumers want to buy. The collection method could be via stored credit card account or via mobile operator billing system. In either case, the Application Store is not delivering a mobile offer to the customer to alert a transaction, and it merely waits for the consumer to shop in the Application Store or catalog, instead of “pushing” offers from the merchant to that merchant's customers. Furthermore, the merchant does not have a direct relationship with the consumer, and the money is not flowing to the merchant first. The Application Store is not processing the payment transaction to the merchants own MID. Instead, the Application Store bills the consumer's account and then splits the revenue collected with the merchant offering the product or service. The Application Store model is an “Aggregation Model” billing on behalf of and sharing revenue with the merchant.
5. Merchants building their own mobile apps with ability to buy: this is essentially the same as the traditional eCommerce transactions via the merchant's own websites. It simply ties into the merchant's existing eCommerce infrastructure and to their payment provider. The consumer must be inside the merchant's application to complete the transaction and purchase.

Accordingly, there is a need for creating and delivering product offers to mobile customers' mobile devices and giving the mobile customers the option to complete purchasing transactions with a plurality of merchants via their mobile phones.

### SUMMARY OF THE INVENTION

The present invention relates to a system and method for delivering and completing mobile commerce and remote commerce transactions. These mobile commerce transactions can be applied to targeted one-to-one marketing, remote coupon offering, and bill payment reminders, among others. The “Commerce Window” (CW) application is used to create a product offer, to deliver the product offer to a mobile customer, and to properly complete the sale and payment transaction with customers on behalf of various merchants, and to ensure the proper order information is processed by the merchant for fulfillment.

The present invention provides a commerce window system for consumer computing devices. It includes consumer computing devices carried by consumers, a commerce gateway server, electronic wallets for consumers, and a plurality of merchants that can create offers on either mobile applications for consumers to shop, or discrete offers that can be embedded in other content providers' applications or advertisements (mobile, TV, Web, print, radio or otherwise) such that these discrete offers can be displayed and transacted upon on the consumers' own mobile phones. The consumer computing devices include a commerce window enabled application and may include an application player which plays applications pushed to the player. The gateway server includes a shopping mall application/commerce application, an offer management system, and a push marketing campaign management system, and communicates with the consumer computing device via a first network connection. The merchants provide product offers to the consumer computing device via the shopping mall application, or advertising in a variety of media to compel consumers to activate a mobile offer and complete a transaction on the spot with their mobile phone. The shopping mall application can include a plurality of mobile storefronts offering products for sale by the plurality of merchants, respectively; or it can contain a single mobile storefront for a single merchant. Each mobile storefront is associated with a specific merchant and includes a specific mobile storefront application. A specific mobile storefront application of a specific merchant is played with the mall application player in the consumer computing device and displays product offers from the specific merchant to the consumer computing device. Each product offer is associated with a product offer identifier and a specific merchant identifier. Each product offer can be a standalone offer embedded into a mobile application or web content, or it can be separately delivered when invoked by the consumer when they press a “Buy Now” button in an advertisement, or short text a number with an offer ID for the product offer to be delivered to his/her phone in real-time for him/her to review the product, and make the purchase

In general, in one aspect the invention features a commerce window system for merchants to deliver commerce functionalities to consumers computing devices without the consumer having to log into a merchant's website to complete purchasing transactions. The commerce window system includes a consumer computing device, a commerce window gateway server and a plurality of merchants. The consumer computing device comprises a commerce application player executable by the consumer computing device. The commerce window gateway server comprises a commerce application and a secure payment application and the commerce window gateway server communicates with the consumer computing device via a first network connection. The merchants provide product offers to the consumer computing device via the commerce application and receive payments via the secure payment application. The commerce application comprises a plurality of commerce offer managers and each commerce offer manager is associated with a specific merchant and comprises a commerce offer application that presents product offers for sale by the specific merchant. A specific commerce offer application of a specific merchant is downloaded and executed by the commerce application player in the consumer computing device and displays product offers from the specific merchant in the consumer computing device. Each commerce offer manager further comprises an offer management application used to generate product offers by the specific merchant. Each product offer is associated with a product offer identifier and a specific merchant identifier.

Implementations of this aspect of the invention may include one or more of the following features. Each of the product offers comprises a product description, price, shipping method and order parameters. Each of the product offers may further comprise collected demographic and marketing information. The product offer identifier comprises automatically generated ID, barcode reader generated ID, or Near Field Communication (NFC) tag. Each commerce offer manager further comprises a marketing application used to respond to consumer requests for product offers by the specific merchant and to push product offers from the specific merchant to the consumer computing device. The product offers are embedded into the commerce offer application. The consumer requests are placed by entering a product offer ID, tapping on a screen image, clicking a “buy-now” button, selecting from a browsing list, text messaging, e-mailing or phone calling. The product offers are pushed to the consumer computing device by the commerce offer manager via text messaging or messaging means utilizing an open socket that listens for push commands. The system may further include one or more additional consumer computing devices and each additional consumer computing device comprises the commerce application player. Each consumer computing device comprises a device identifier and each product offer is further associated with the device identifiers of the consumer computing devices that have elected to receive the product offer. The commerce application player is configured to download and execute a plurality of commerce offer applications displaying products offered by a plurality of merchants, respectively and the plurality of merchants were previously selected by a user of the consumer computing device. The commerce window gateway server further includes a first table comprising the association of each product offer with a product offer identifier, a specific merchant identifier, a device identifier and an affiliate third party identifier. The system may further include one or more payment processors. The payment processors communicate with the secure payment application of the commerce window gateway server and process payments for the products offered for sale by the plurality of merchants. The commerce window gateway server further includes a second table associating each of the specific merchant identifiers with the one or more payment processors. The secure payment application stores previously used payment instruments in user accounts associated with each consumer. Each consumer accesses a user account via an authentication mechanism comprising one of providing a user name and password, voice authentication or biometric authentication. The secure payment application delivers payment information to a payment processor associated with a specific merchant and the payment information comprises payment instrument, payment amount and specific product purchased. The secure payment application further receives payment confirmation from the payment processor upon completion of payment and forwards the payment confirmation to the commerce offer manager of the specific merchant. Each commerce offer manager further includes a fulfillment application. The fulfillment application processes order fulfillment and product shipping upon receipt of the payment confirmation. The consumer computing device comprises a managed code environment and the commerce application player is executed within the managed code environment. The managed code environment may be a Small Technical Interoperability Platform Virtual Machine (STIP VM), J2ME, .NET, or Flash Lite. The commerce application player comprises a rich and secure client application configured to display the product offers via text, graphics, video or audio. The commerce application player is configured to be woken up manually or automatically via text messaging or a TCP/IP socket listener. The commerce application player is dynamically downloaded to the consumer computing device via a link embedded in an advertisement of a product offer or in response to a user's request for a specific product offer. The commerce application player is preloaded to the consumer computing device. The consumer computing device may be a mobile phone, PDA, payment module, portable computer, personal computer, set-top box, netbook, tablets, iPad, electronic reader or an Internet appliance. The system may further include an advertising application, and the advertising application presents advertisements of product offers to the consumer computing device via the commerce offer application. The advertising application is comprised within the commerce window gateway server or within an affiliated third party API. The product advertisements comprise links to commerce offer applications of merchants providing the product offers. Product offers of a specific merchant are requested by a user of the consumer computing device via the merchant's downloaded specific commerce offer application or via an affiliated third party application. The commerce application player further comprises a request for product offers application for pulling advertisements of products and product offers provided by the commerce offer managers. The request for product offers application pulls advertisements of products and product offers via a product code, bar code, NFC tag, phone call, web request or text message. The commerce application player may further include an account manager, security data and user authentication data.

In general, in another aspect, the invention features a method for merchants to deliver commerce functionalities to consumers computing devices without the consumer having to log into a merchant's website to complete purchasing transactions. The method includes providing a consumer computing device comprising a commerce application player executable by the consumer computing device, providing a commerce window gateway server comprising a commerce application and a secure payment application and providing a plurality of merchants configured to provide product offers to the consumer computing device via the commerce application and to receive payments via the secure payment application. The commerce window gateway server communicates with the consumer computing device via a first network connection. The commerce application comprises a plurality of commerce offer managers and each commerce offer manager is associated with a specific merchant and comprises a commerce offer application that presents product offers for sale by the specific merchant. A specific commerce offer application of a specific merchant is downloaded and executed by the commerce application player in the consumer computing device and displays product offers from the specific merchant in the consumer computing device. Each commerce offer manager further comprises an offer management application used to create product offers by the specific merchant and each product offer is associated with a product offer identifier and a specific merchant identifier.

In general, in another aspect, the invention features a method for merchants to deliver commerce functionalities to consumers computing devices without the consumer having to log into a merchant's website to complete purchasing transactions. The method includes providing a consumer computing device, providing a commerce window gateway server comprising a commerce application and registering a plurality of merchants into the commerce application and for each merchant generating a commerce offer manager with the commerce application. The commerce offer manager comprises a commerce offer application configured to provide product offers from the merchant to the consumer computing device via the commerce window gateway server. Next, signing-up a user of the consumer computing device to purchase products offered by the merchant via the commerce offer application. Downloading and installing a commerce application player into the consumer computing device. Downloading and executing the commerce offer application of the merchant in the consumer computing device with the commerce application player and displaying product offers from the specific merchant in the consumer computing s device. Each product offer is associated with a product offer identifier and a specific merchant identifier. The commerce window gateway server further comprises a payment application and the payment application stores previously used payment instruments in user accounts associated with each consumer computing device. The method further includes delivering payment information by the payment application to a payment processor associated with a specific merchant. The payment information comprises payment instrument, payment amount and specific product purchased via the consumer computing device.

Among the advantages of this invention may be one or more of the following. The “Commerce Window” (CW) of the present application represents “eCommerce 2.0” methodology, whereby an intermediary service or system is used to facilitate the order presentation, the gathering of consumer payment and related information, order parameters, and to complete the transaction on behalf of the merchant and the consumer on a mobile device or computing device. The Commerce Window intermediary service can be hosted by a third party or by the merchant itself. The Commerce Window (CW) consists of three major components: 1) payment processing on behalf of a specific merchant. 2) order parameter and fulfillment processing on behalf of the specific merchant, (size, quantity, color, etc.) 3) management of consumer payment instruments (e-wallet) and receipts, to enhance consumer convenience. CW can embed the commerce transaction process into any application or website on behalf of any merchant without leaving the application and redirecting the consumer to that merchant's shopping site in order to complete a transaction. Commerce Window can be embedded within a merchant's own shopping application or in an advertisement in a third party's application, such that when a consumer press a “Buy Now” button in the shopping application, or the advertisement, the rest of the commerce transaction can take place securely via the commerce window. Commerce Window can also be prompted by a consumer via SMS and other means to be delivered to a consumer's own mobile phone to invoke advertising in print, TV, Web, radio, and other mobile content applications, among others. The Commerce Window can be a standalone application “pushed” to the consumer's mobile or computing device for the sole purpose of completing a single transaction between a merchant and a consumer. The “push” can be initiated by either the consumer upon requesting an offer to be sent to his/her phone through a variety of means from scanning a barcode to sending a short text with the offer ID, or the “push” can be generated by a merchant who knows the consumer and generally has permission from the consumer to make such an offer through a “Push marketing” campaign management system. Commerce Window can also be embedded within a variety of mobile applications itself, or a variety of advertising for consumers to request product information and be able to transact.

The commerce window application of the present invention is analogous to an offer or a bill sent to a consumer by mail with an order form and a self-addressed stamped envelope for the consumer to mail back the order and payment. No such mechanism or system exists currently for mobile phones. The commerce window application of the present invention allows product offers and bills to be sent to a consumer's own mobile phone, and allows the purchase transaction to be completed instantly on the spot using payment information entered or stored by the system. This is the next generation of electronic transactions for convenient remote commerce.

Unlike a Uniform Resource Identifier (URI) link that takes the user off to another website, the commerce window application always stays with the secure commerce gateway server and thus cannot not be spoofed easily. The commerce window product offers can be personalized and targeted, between the merchant and the consumer. The commerce window application offers the merchants a direct path to consumers. Any type of goods and services can be offered through this methodology. The commerce window application utilizes the traditional risk models of credit card payment processors, and not the billing system of a mobile phone operator, which is not designed to handle risk for purchasing physical goods. One-to-one marketing offers, coupons, alerts, bill payment reminders can be sent with payments conducted via the commerce window application. These offers can come in the form of text, graphics or even audio and video Multimedia Messaging Service (MMS) messages. The commerce window application can be presented to a PC, or a set top box to be displayed to the user, and to evoke a response for transaction. What is unique about the commerce window application is the ability to associate a merchant's own identifier (MID) with the specific offer identifiers or Offer ID. Therefore, the commerce window application does not have to bring a consumer to a different website via a web browser which may or may not be secure, and make the consumer go through a cumbersome shopping cart and payment process. The transaction can be completed on the spot. Many mobile devices or set-top boxes do not have a good browser or user interface thus a commerce window application is a secure and efficient way to conduct a remote offer and transaction.

### BRIEF DESCRIPTION OF THE DRAWINGS

FIG. 1A is an overview diagram of the commerce window system;

FIG. 1B is a detailed diagram of the commerce window gateway server of FIG. 1A;

FIG. 1C is a detailed diagram of the commerce application player of FIG. 1A;

FIG. 2 is a screenshot of a product offer presented via the commerce application player in the mobile phone;

FIG. 3 is a screenshot of the “Secure Fastpay” screen in the mobile phone;

FIG. 4 is a screenshot of the “Find Deals” screen in the mobile phone;

FIG. 5 is a screenshot of the order placement screen in the mobile phone;

FIG. 6 is a flow diagram of a commerce window transaction;

FIG. 7 depicts screenshots for selecting a product, searching the selected product and entering the order parameters using the commerce window system of FIG. 1A and the commerce application player of FIG. 1C in a mobile phone;

FIG. 8 depicts screenshots for confirming the purchase of the product of FIG. 7, paying for the product and sending the fulfillment request and receipt;

FIG. 9 depicts screenshots for searching for product offers, finding the value of the day and making a purchase using the commerce window system of FIG. 1A and the commerce application player of FIG. 1C in a mobile phone;

FIG. 10 depicts screenshots for sending a push marketing text message to a customer's mobile phone, showing the deal and making a purchase using the commerce window system of FIG. 1A and the commerce application player of FIG. 1C in the mobile phone;

FIG. 11 depicts screenshots for searching for the value of the day, making a purchase and redeeming a coupon using the commerce window system of FIG. 1A and the commerce application player of FIG. 1C in a mobile phone;

FIG. 12 depicts a screenshot for presenting product offers from three different merchants in a consumer's PC using the commerce window system of FIG. 1A and the commerce application player of FIG. 1C;

FIG. 13 depicts a screenshot for presenting a product offer using the commerce window system of FIG. 1A and the commerce application player of FIG. 1C in a mobile phone;

FIG. 13A depicts a screenshot for selecting product parameters for the product of FIG. 13;

FIG. 13B depicts a screenshot for selecting the quantity for the product of FIG. 13;

FIG. 14A depicts a screenshot for login into a consumer's stored wallet using the commerce window system of FIG. 1A and the commerce application player of FIG. 1C;

FIG. 14B depicts a screenshot for selecting a specific credit card for payment using the commerce window system of FIG. 1A and the commerce application player of FIG. 1C;

FIG. 15 depicts a screenshot for confirming the purchase parameters for the product in FIG. 13;

FIG. 16 depicts a screenshot for confirming the purchase of the product in FIG. 13; and

FIG. 17 depicts a screenshot confirming the completion of the purchase of the product in FIG. 13.

### DETAILED DESCRIPTION OF THE INVENTION

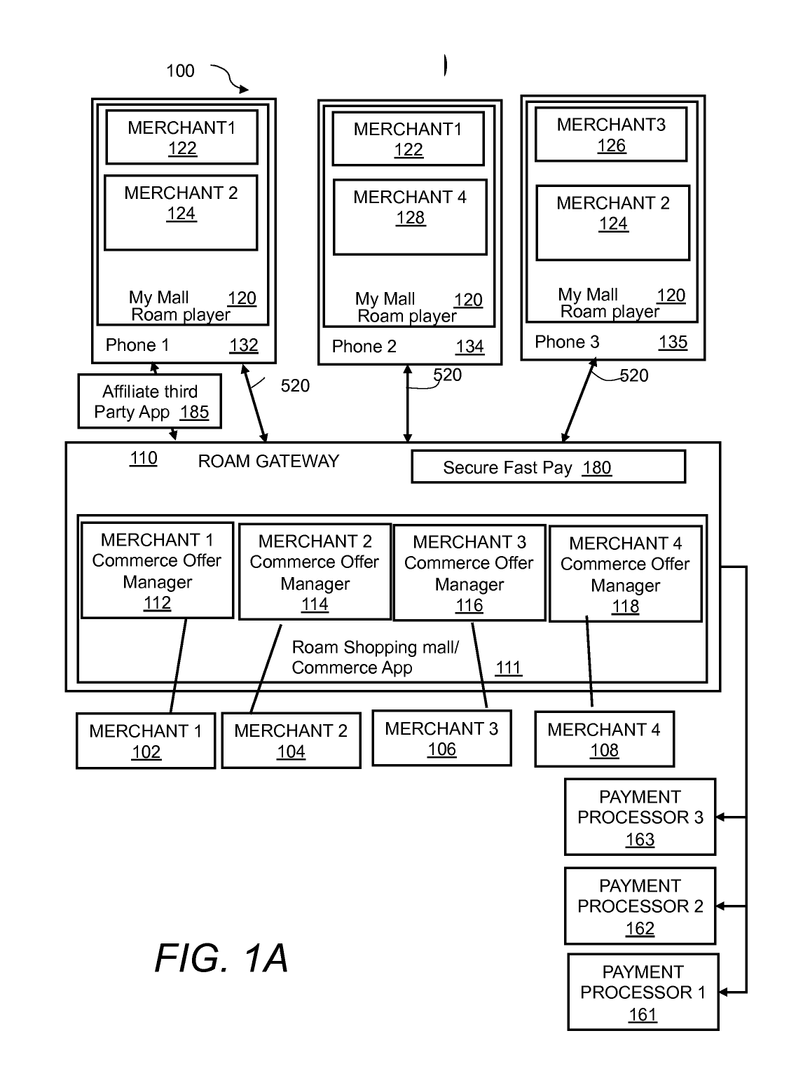

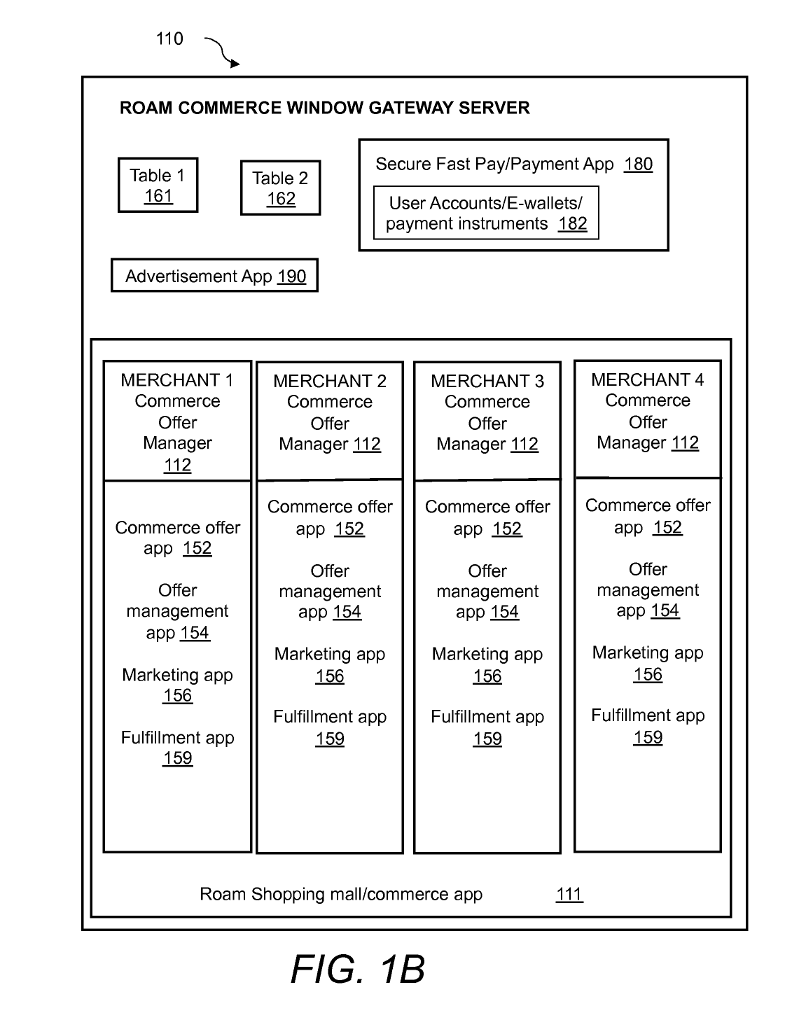

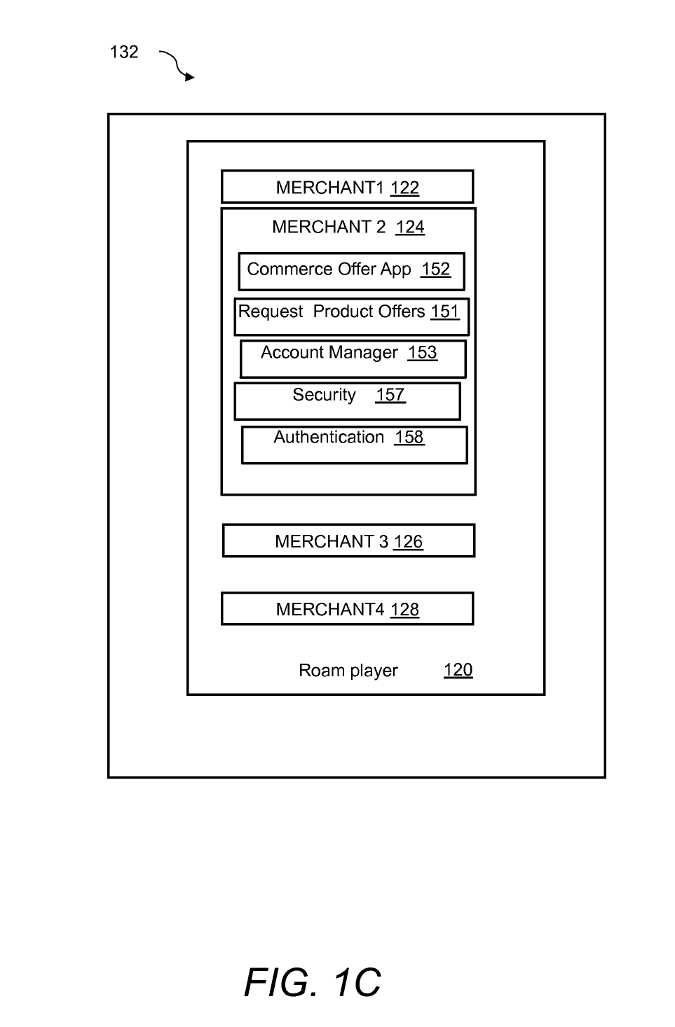

Referring to FIG. 1A, the commerce window system 100 for mobile devices includes mobile phone devices (or consumer computing devices) 132, 134, 135, that interact with the Roam gateway server 110 (or commerce window gateway server) via network connections 520. The Roam gateway server 110 includes a shopping mall application 111 (or commerce application) that manages multiple merchant storefronts 112, 114, 116, 118 (or commerce offer managers) and a secure payment application (“Secure Fastpay”) 180. Referring to FIG. 1B, each merchant storefront (commerce offer manager) includes a specific mobile storefront application 152 (or commerce offer application), an offer management application 154, a marketing campaign management application 156 and a fulfillment application 159. The merchant generates product offers with the offer management application 154 and then uses the commerce offer application 152 to present the product offers to consumers' mobile devices. The marketing campaign application 156 responds to consumer requests for specific product offers and pushes product offers to selected customers via text messages as will be described below. The fulfillment application 159 fulfills the purchase order and arranges the shipping of the purchased product after receiving confirmation of payment from the payment application 180. The Roam gateway server 110 also includes an advertising application 190, and the advertising application 190 presents advertisements of product offers to the consumer computing devices 132, 134, 135 via the commerce offer application 120. The advertising application 190 is comprised within the commerce window gateway server 110, as shown in FIG. 1B, or within an affiliated third party application programming interface API 185, shown in FIG. 1A. The product advertisements include links to commerce offer applications 152 of merchants providing the product offers. Product offers of a specific merchant are also requested by the consumers via the merchant's downloaded specific commerce offer application 152 or via an affiliated third party application 185.

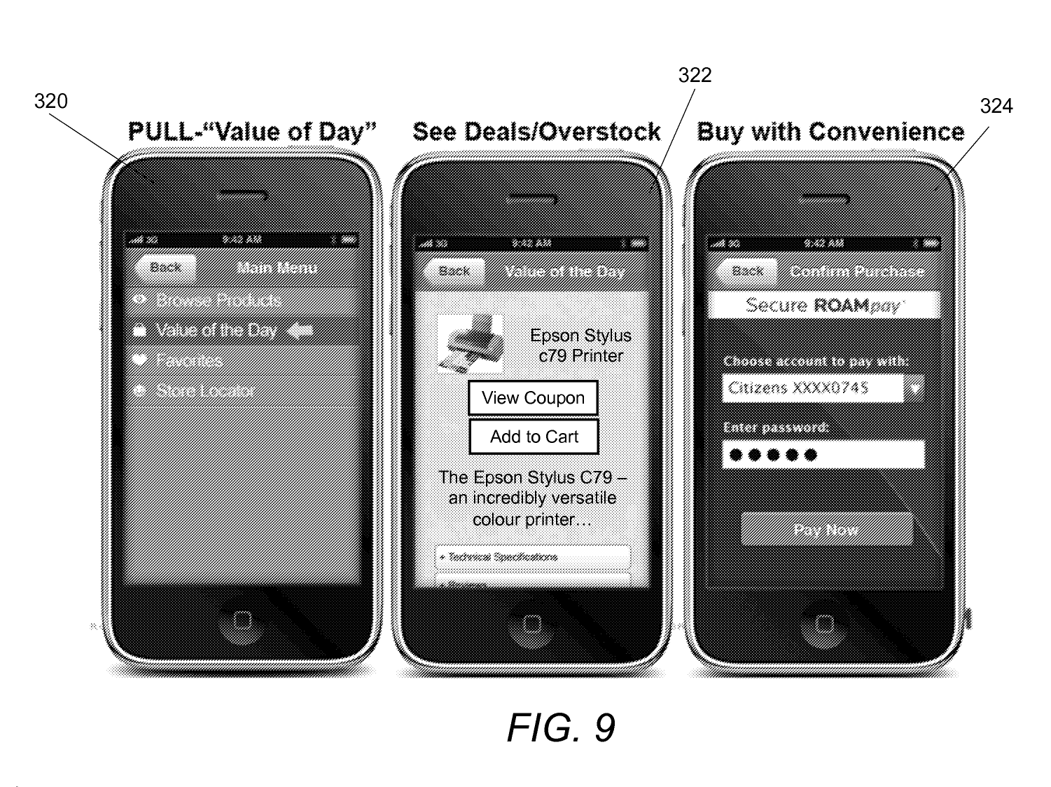

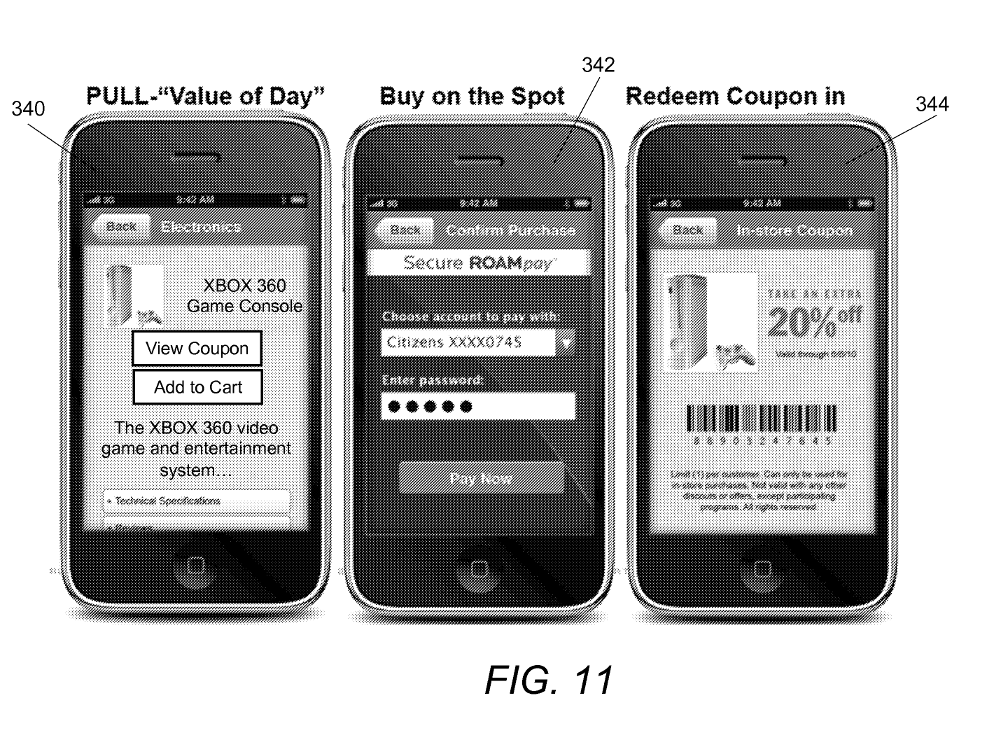

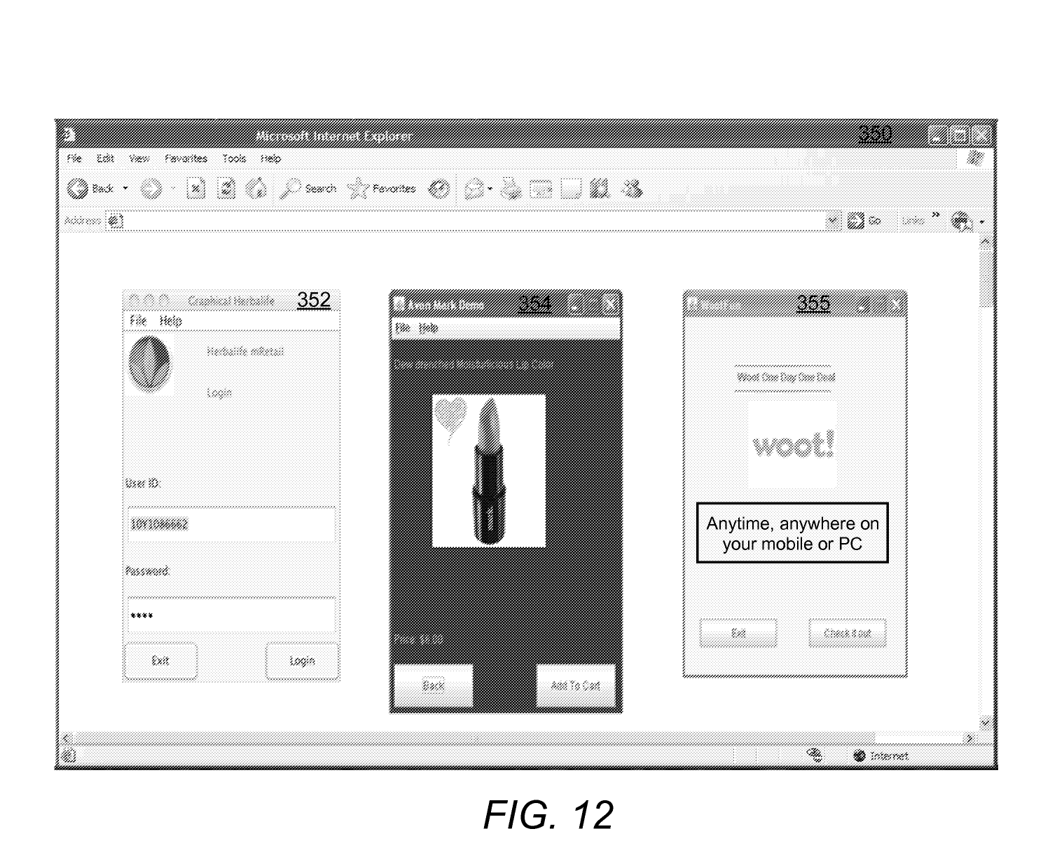

Mobile devices 132, 134, 135 may be any type or format of a mobile device utilizing any type of operating system. Referring to FIG. 1C, mobile devices 132, 134, 135 include a “My Mall Roam player”, a virtual machine type application 120 (or a commerce window player) that plays and/or displays mobile storefront applications 152 from merchants that were selected by the consumer. In the example of FIG. 12, the commerce window player 350 displays three different mobile storefronts 352, 354, 355 in a personal computer. The different mobile storefront applications (commerce offer application) 152 may be different applications played by the player or can be encompassed by one larger application with multiple storefronts in one application. In the example of FIG. 1A the user of phone 1 selected to have storefronts 122, 124, of merchants 1 and 2, respectively. The user of phone 2 selected to have storefronts 122, 128 of merchants 1 and 4, respectively. Similarly, the user of phone 3 selected to have storefronts 126, 124 of merchants 3 and 2, respectively. The commerce window player 120 also includes an account manager 153, and security 157 and authentication 158 data, shown in FIG. 1C. The account manager 153 manages the details of the account information, such as name, address, shipping information and payment instruments, among others. The authentication data 158 include user name and password, or authentication tokens, or voice or other biometric authentication data. The commerce window player 132 also includes a “Request for Product Offers” application 151 used by the user of the computing device to pull advertisements of products and product offers provided by the various commerce offer managers, as shown in FIG. 9 and FIG. 11. This is an exemplary diagram and therefore the system 100 may include less or more than three mobile devices and less or more than four merchants. Mobile phones 132, 134, 135 belong to consumers that use the devices to perform purchasing transactions. The mobile devices 132, 134, 135 may be mobile phones, PC, set top boxes, Net Books, Kindle and other internet appliances. The Roam Gateway server 110 also connects to payment processors 161, 162, 163 that process payments for the products offered and purchased through the commerce window system 100.

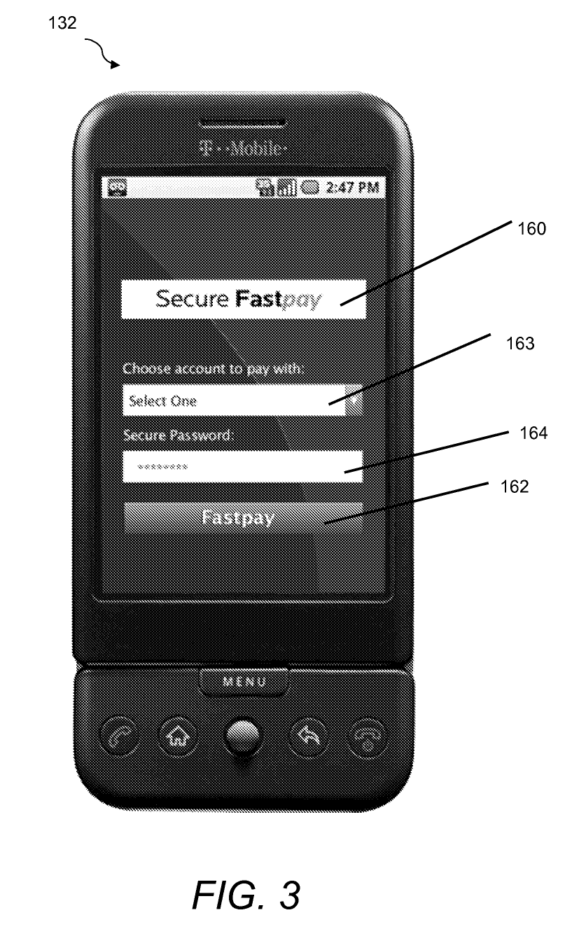

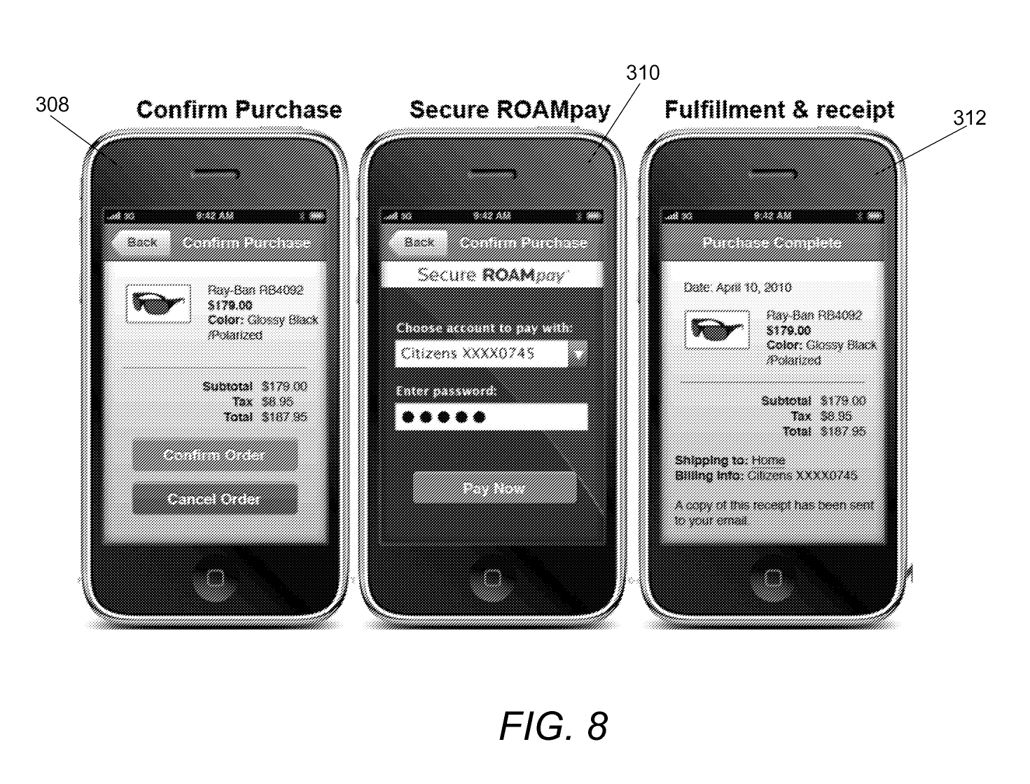

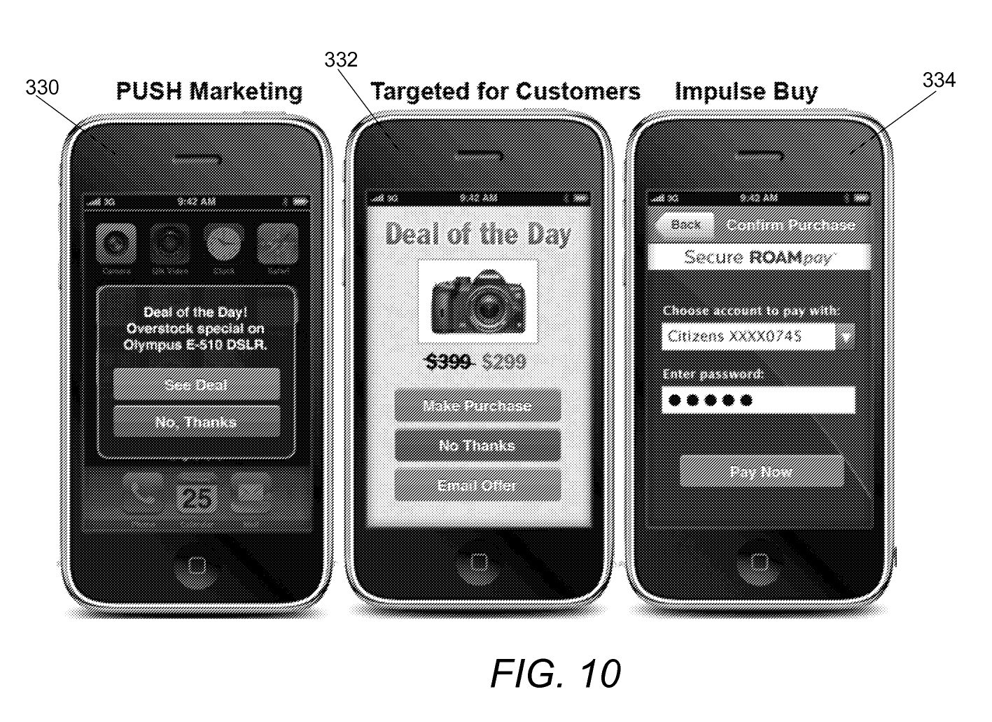

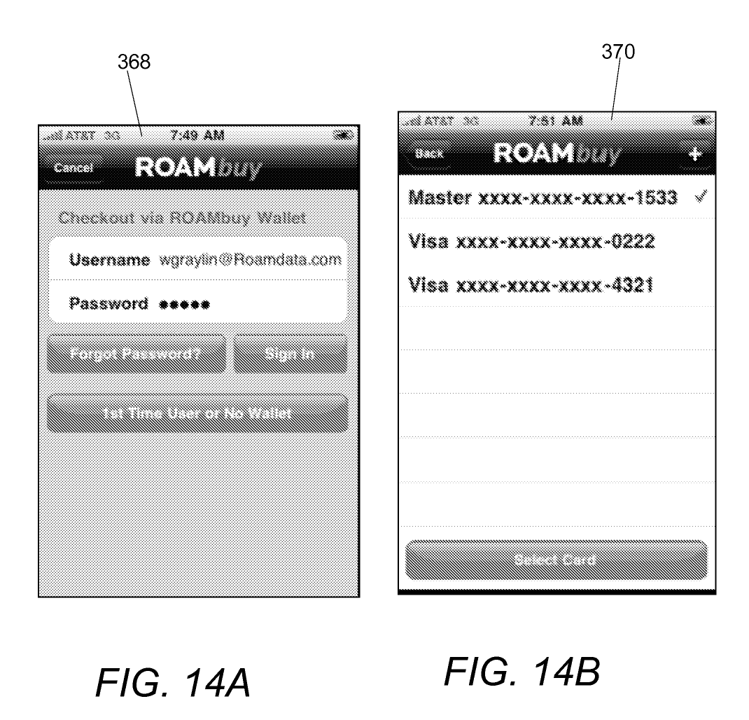

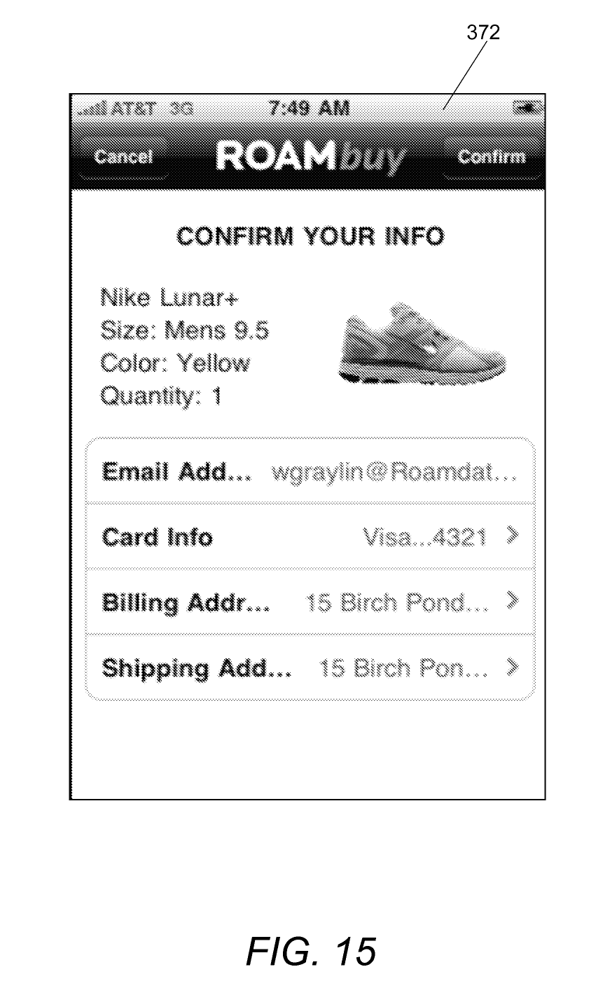

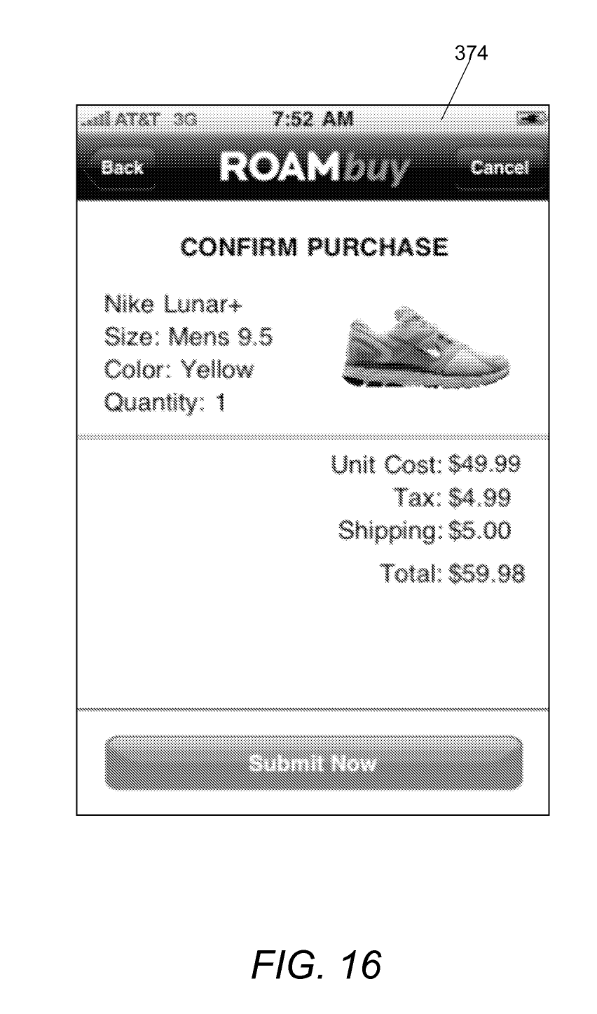

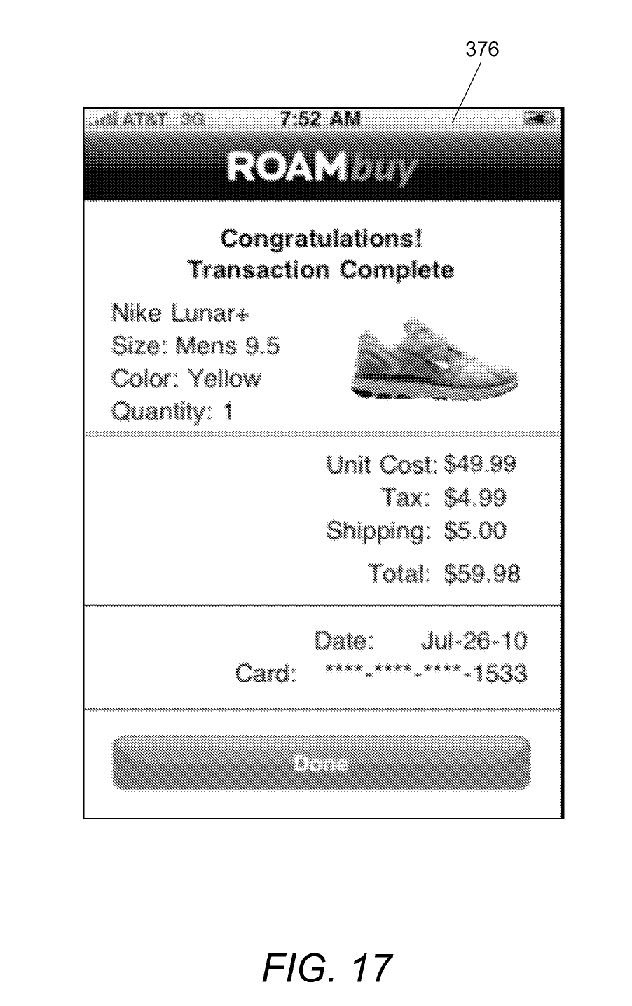

Commerce Window Gateway (CWG) 110 is a gateway server, which provides and supports the commerce window applications 111. CWG delivers product offers to remote terminals 132, 134, 135 and manages these product offers, including the association of the offer with a given product offer ID with a merchant's ID (MID), and to which consumer/user or device (device ID) such an offer goes to. The product offer ID may also be associated with an affiliated third party 185, if the product is presented to the consumer through the affiliated third party. This association of the product ID with the merchant ID, the device ID and the affiliate ID is stored in Table 1 161, shown in FIG. 1B. The MID is also associated with a given payment processor 161, 162, 163. Each payment processor may process different payment instruments and its main job is to authorize payment and deposit funds to the merchant's account if the payment instrument used is valid and has sufficient funds. Table 2 162 stores these payment data associations with the merchant IDs. If the consumer completes the payment transaction via the commerce window, order information, total amount and payment information are sent to the CWG 110. Payment information can be taken directly from the consumer (i.e. credit card information) each time he/she transacts (“normal pay”). The consumer may also register for “Secure Fastpay” 180, which allows previously used payment instruments to be stored in user accounts or e-wallets 182 and then to be used again quickly with an authentication by the user, as shown in FIG. 1B, FIG. 3, FIG. 8, FIG. 9, FIG. 10, FIG. 11 and FIG. 14B. The payment instrument may be credit cards (shown in FIG. 14B), prepaid debit cards, PayPal accounts, ACH, among others. The user authentication may be performed via a username and password, as shown in FIG. 14A. In other embodiments, user authentication is based on an authentication token or method, voice or other biometric information. The payment transaction is completed by the commerce window application by delivering the right payment instrument (stored or new), the right total amount, to the right processor, for the right MID, based on the right offer ID. CWG 110 also tracks for the offers being sent whether they have been opened, viewed, offered declined or accepted. The CWG 110 has access to the various payment processors that the merchants accept payment on, and therefore the CWG 110 is able to route the transactions from each offer to the right processor. The CWG is PCI compliant to properly guard cardholder information securely. The commerce window application is written in a number of languages and uses a number of techniques to display offers, communicate securely with a CWG (a secure server), to deliver and confirm the right transactions. In one example, the CWG is the Roam Server 3000 described in U.S. application Ser. No. 12/198,944 filed on Aug. 27, 2008 and entitled SYSTEM AND METHOD FOR DEVELOPING RICH INTERNET APPLICATIONS FOR REMOTE COMPUTING DEVICES which is commonly assigned and the contents of which are expressly incorporated herein by reference.

Product offers can be customized by the merchants with the marketing campaign management application 156 to target either a group of users, or a single user. Users are identified by a cell phone number, email address or set top box ID, among others. In the case of one-to-one marketing, the more information is known about the target user/consumer, the more secure and relevant the product offers become. Users/consumers can “opt in” for promotions and offers, in which case they would voluntarily provide their own account information stored with the CWG, or the merchant can provide such account information for having done business with the user/consumer. If one does not use an “opt in” model, then relevant and timely offers are essential to not create a spamming effect.

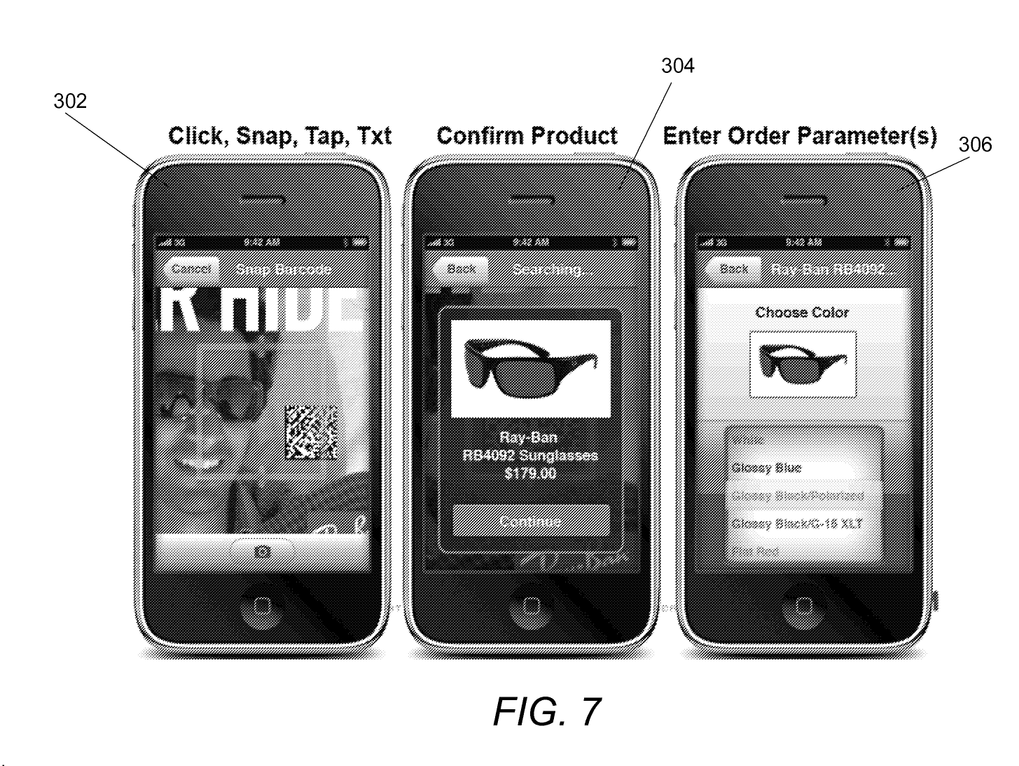

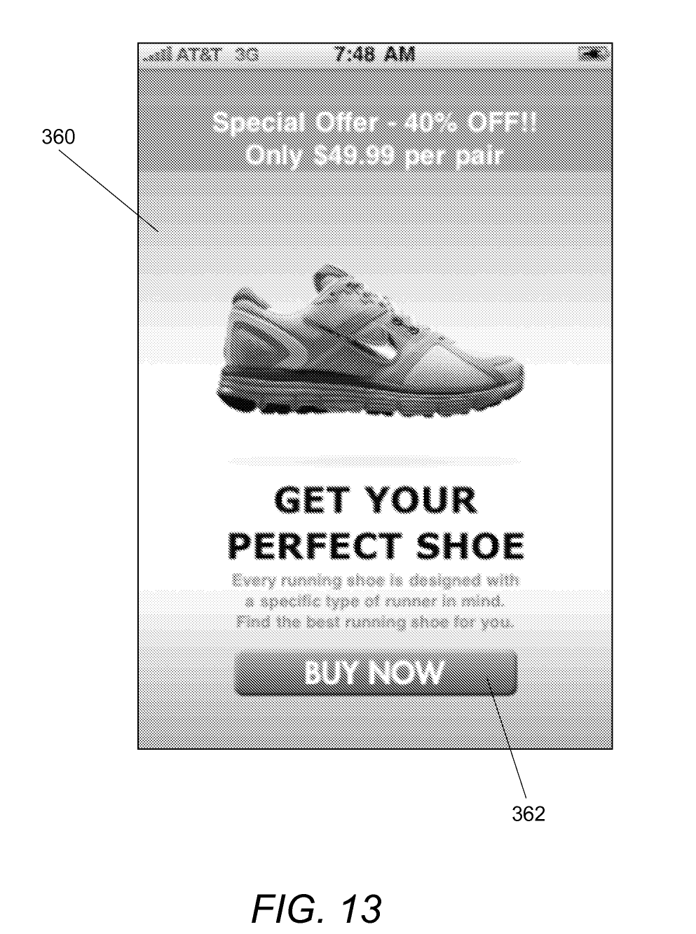

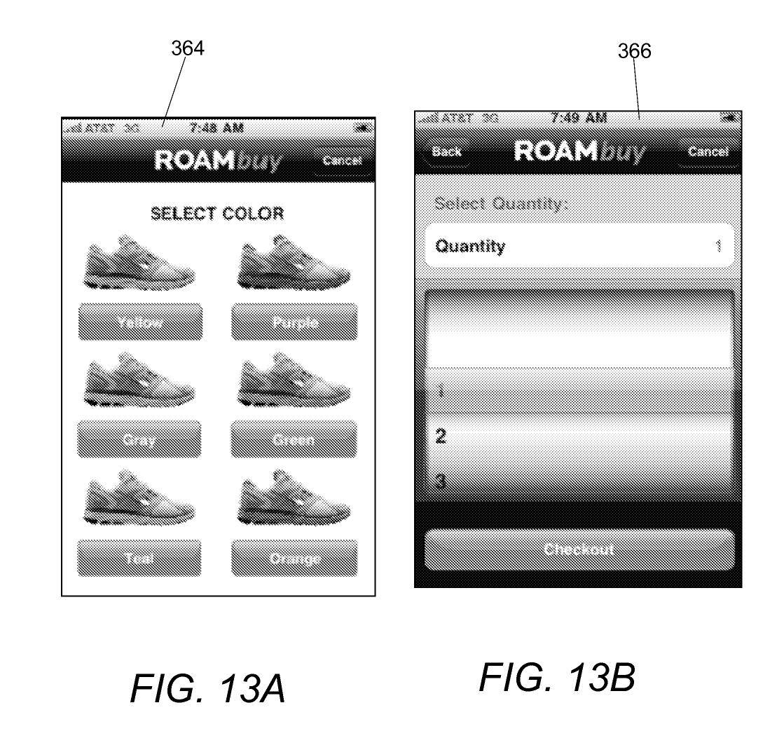

The commerce window player 120 is a rich and secure client application. Referring to FIG. 10, in a “push” marketing application, commerce window player 120 wakes up by receiving an SMS/MMS message 330 or by a Transmission Control Protocol/Internet Protocol (TCP/IP) socket listener, and displays the product offer in text, graphics, video, audio to the user and prompts for a response and action. As shown in FIG. 10, the user opens the “deal of the day” offer 332 and completes the purchase 334. The commerce window player 120 displays offers from any merchant who wishes to present offers via the CWG. Referring to FIG. 9 and FIG. 11, the commerce window player 120 may be also used to browse product offers 320, “pull” or request for offers 340, complete the purchase 342 and redeem coupons 344. The requested offers may be from a specific store, or for a specific product, or just the best “value of the day” offer. The display of the product offer includes a brief description of the product, technical specifications, price information, store location and coupons, among others. A specific product offer may be searched by snapping a product image and sending a text message to the commerce window server 110, as shown in FIG. 7. In other embodiments, a product offer is searched by tapping on a product image, clicking on a product offer link, or clicking/tapping on a “buy now” button 362, shown in FIG. 13. Next, the searched product offer is displayed 304, shown in FIG. 7 and then the product order parameters are entered 306, shown in FIG. 7. The product order parameters include color, size, accessories, and quantity, among others.

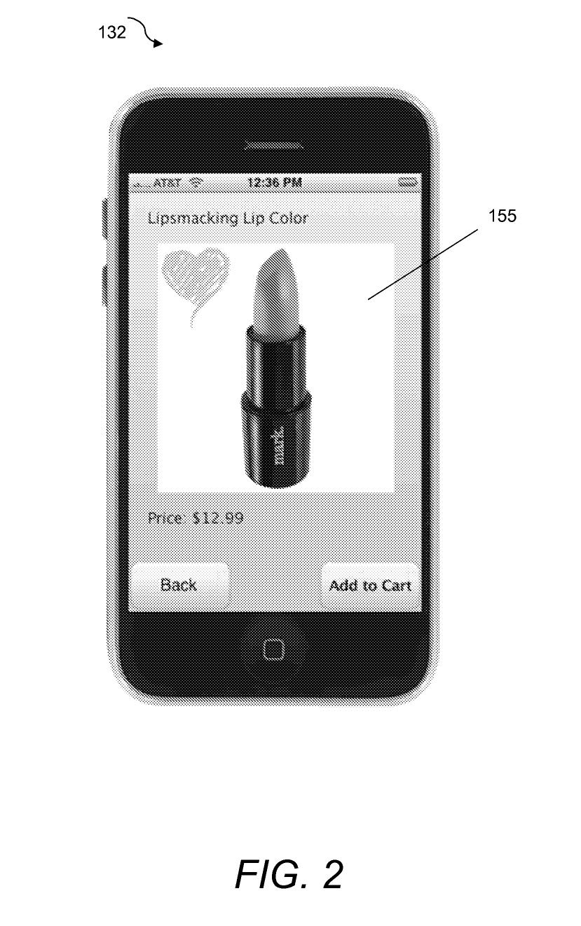

The commerce window player 120 may be preloaded to the computing device, or dynamically loaded at the time of the offer presentation via a link. The commerce window player 120 may also be obtained via an application store as a mobile application that can provide remote commerce and bill payment capabilities. Alternatively, commerce window player 120 may be downloaded over the air via a link to the CWG's provisioning server. In the case of a PC/MAC computer, the commerce window player 120 simply comes in the form of a Java application downloaded onto the user/consumers' PC/MAC at the time of the offer. To ensure authenticity and security of the commerce window player 120 (i.e., a genuine commerce window player from a trusted CWG provider) to consumers, a proper certification logo is displayed. Of course, there can be fake commerce window players, just like there are fake ATMs and POS devices, but proper care should be taken to ensure that consumers feel safe to use the commerce window player. If the commerce window player 120 is not already loaded on a remote terminal such as a mobile device, the merchant can ask their consumers/users to load the commerce window player voluntarily for some benefit they provide. FIG. 2 depicts a screenshot 155 of an offer for a lipstick product presented to a consumer via the commerce window player 120 in their mobile phone. In one example, the commerce window player is the Roam player 1110 described in U.S. application Ser. No. 12/198,944 filed on Aug. 27, 2008 and entitled SYSTEM AND METHOD FOR DEVELOPING RICH INTERNET APPLICATIONS FOR REMOTE COMPUTING DEVICES which is commonly assigned and the contents of which are expressly incorporated herein by reference.

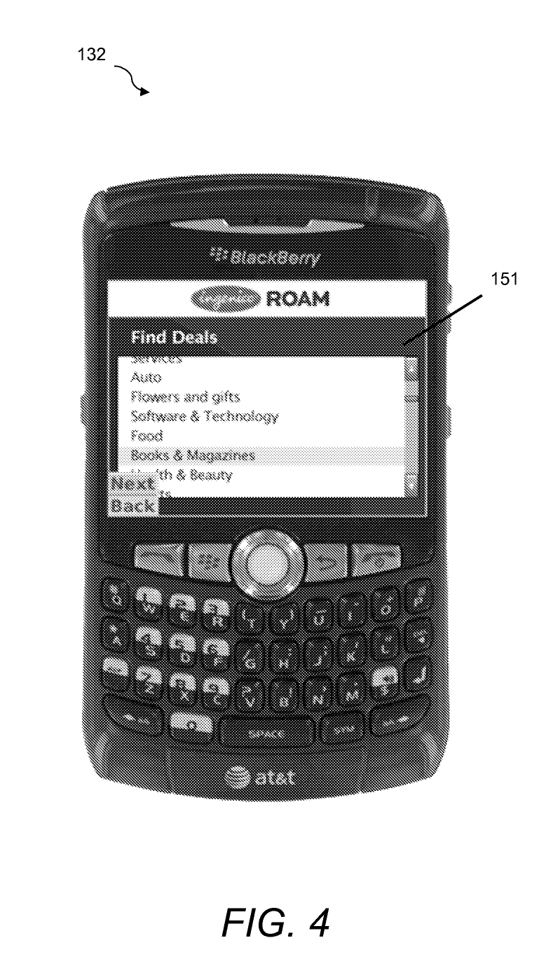

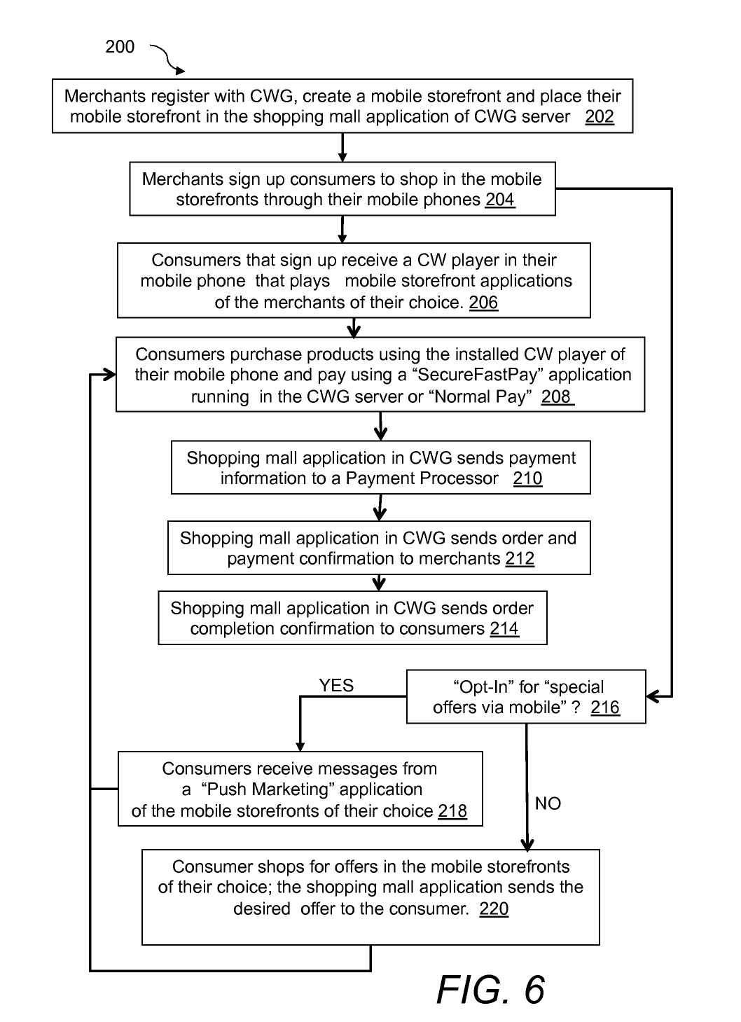

Referring to FIG. 6, the process 200 for conducting a commerce window transaction includes the following. First, merchants 102, 104, 106, 108 register with a trusted third party Commerce Window Gateway (CWG) 110, (i.e., Roam Data Gateway), and they use the Roam integrated development environment (IDE) to create mobile storefront applications 112, 114, 116, 118, respectively. The Roam IDE is described in U.S. application Ser. No. 12/198,944 filed on Aug. 27, 2008 and entitled SYSTEM AND METHOD FOR DEVELOPING RICH INTERNET APPLICATIONS FOR REMOTE COMPUTING DEVICES which is commonly assigned and the contents of which are expressly incorporated herein by reference. The merchants 102, 104, 106, 108 use their mobile storefront applications to offer products and services to consumers 132, 134, 135 through their mobile devices and to do “pull marketing” or “push marketing”. Once the applications are completed, merchants 102, 104, 106, 108 place their corresponding storefronts 112, 114, 116, 118 in the ROAM shopping mall 111 (202). Next, merchants 102, 104, 106, 108 convince and direct their customers to sign up for their mobile storefront applications 112, 114, 116, 118 (204). They also try to convince their customers to Opt-In to their “special offers via mobile” (216). A consumer that signs up for the mobile storefront application receives a special software on their phone 132 called a Roam player or a commerce window player 120 (206). Roam player 120 enables a consumer to have various ROAM applications including mobile storefront applications 122, 124 for shopping on their mobile phone and to access the merchant's “mobile storefront” 112, 114, respectively. The merchant that signs up the consumer first will have their “mobile storefront” 122 on the very top of the list. The consumer can add other mobile shops to his/her mobile mall through a web interface or through the Roam player application itself. Next, the consumer can shop anytime, at the mobile storefront of his/her choice (208). The first time the consumer actually buys something he/she can choose to register for “Secure FastPay” 160, shown in FIG. 3. “Secure FastPay” 160 takes the users' cardholder information 163, and creates a password 164 for authenticating future payments. The consumer's mobile phone number is checked with various sources to confirm and improve authentication. In one example, the name on the phone number is matched to the name on the credit card, or to the mailing address on the credit card. If a match is confirmed then “Secure FastPay” 160 is set up on the mobile phone 1. If it does not match, the CWG server 110 declines the transaction. Multiple declines can lead to termination of the Roam player 120 or the cell phone number from further access to the system. When the consumer “Opts-In” for special offers via mobile, (216) then “Push Marketing” can take place via a special SMS or MMS alert that wakes up the Roam player software application 120, which then presents commerce windows to complete offers and transactions based on the Offer ID, as was shown in FIG. 10 (218). A merchant 102 who wants to place an offer, uses the “Push Marketing” campaign manager (PMCM) in the mobile storefront application 112 to create the offer and to associate the offer with a unique Offer ID. The start time and end time of the offer, SKU, price, description, max and min quantities, images are all specified and loaded into the PMCM software. The merchant then selects the recipients it is sending the offer to, which can be based on a number of filters and criteria. Examples of these filters and criteria include demographics, interests, spend patterns, only one's own customers, all mobile customers with a Roam player (who opted in), only those who shopped for certain products, among others. Alternatively, the recipient or a consumer that has not signed for “Opt-In” may search and self select an offer (“pull marketing”, by punching in a short code, snapping a product image, entering a barcode or and NFC tag via text messaging, or some other method, for the offer to be delivered to his/her mobile phone(220), as shown in FIG. 4. Once an offer is completed with specific Offer ID and the recipients are identified in the system, then the commerce window gateway (CWG) delivers the offers at the specified times via a special SMS, or MMS, or a TCP/IP socket listener. The CWG measures and tracks the adoption rate and click throws. The recipient/consumer gets the offer and can choose to
a. “Buy Now” or “Yes”—to open rest of offer and shop/Buy.
b. “Not Now” or “No” then the further choice of:
   i. Forward—forward to another phone number or email.
   ii. Save—save to SMS for later action.

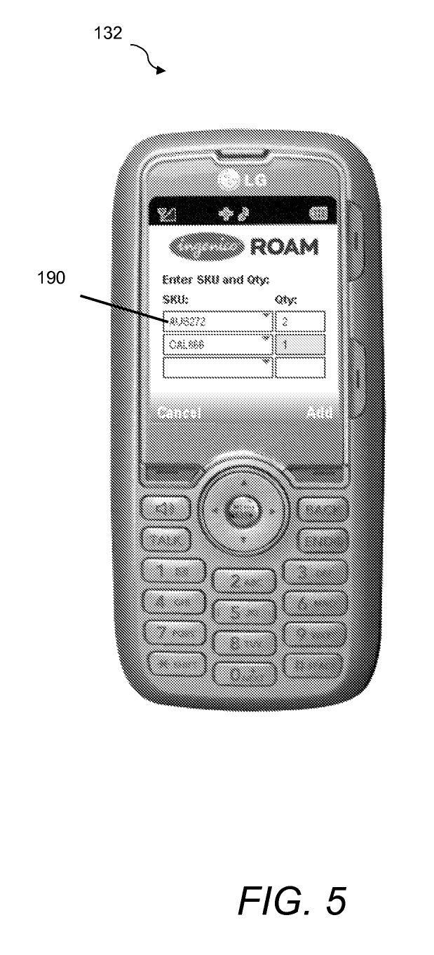

If the recipient chooses “Buy Now” or “Yes”, then the mobile storefront application of the merchant that has made the offer appears and the consumer can select quantity, parameters, based on the offer and proceed to checkout (208). Before commerce window completes the checkout, it checks with the CWG which checks with the PMCM the validity of the offer, with the merchant to verify inventory, or date that offer is still valid before it proceeds to payment. Once confirmed (if needed) then it proceeds to checkout. Here the recipient can choose “Normal Pay”, or “Secure FastPay. In the case of “Normal Pay” the consumer enters a new payment card information for the first time. At the end of “Normal Pay” session, the consumer has the option to register for “Secure FastPay”. Choosing the “Secure FastPay” option results in validating payment and cardholder information and assigning a password for authentication. Near Field Communication (NFC) payment or Swipe Card Present Payment (SCPP) can also be registered for “Secure FastPay” as payment instruments, along with Automated Clearing House (ACH) and Paypal, among other. “Secure FastPay” may store multiple payment instruments for the user to select. In one example, the user has the options to select between “Account ending in XXXX2035”, or “Account ending in XXXX1135”. Next, “Secure Fastpay” 180 directs payments to payment processors 161, 162, 163, which process credit card payments, debit card payments and direct wire payments (210), shown in FIG. 1. FIG. 3 depicts a screenshot 160 of the Secure Fastpay window 162, including selecting the account to make payment 163 and the authentication password 164. In order to complete the transaction Roam gateway 110 needs to receive the order with information including confirmation to buy certain quantity of products/services, (Order Information OOO), totaling value of XXX, with Offer ID YYY, and payment instrument of ZZZ, as shown in FIG. 5. Based on Offer ID YYY, Roam gateway 110 matches a data table to merchant ID AAA, on payment processor BBB, and completes the appropriate payment transaction for the appropriate amount to be paid to the appropriate merchant ID AAA. Once payment is confirmed by the payment processor, then the Order information OOO is sent by Roam gateway server 110 to the merchant for further processing (212). The merchant sends confirmation that the order is received and then Roam gateway 110 notifies the consumer on their mobile phone application that the order is completed (214). The merchant then fulfills the order with the fulfillment application 159 and sends fulfillment confirmation to the consumer. An email receipt is also sent to the consumer based on registered information. The consumer also has a “myROAM” account where he/she can check what transactions it has conducted, and which “mobile storefronts” he/she wants to add/delete and Opt In for offers.

“Commerce window” transactions are different from traditional e-commerce transactions for the following reasons: “Commerce window” transactions combine the principles of POS transactions and e-commerce transactions together in one embodiment with the added advantage of delivering specific offers to the consumers' mobile phones with a unique Offer ID which is then tied to the merchants' MID. Unlike POS terminals and e-Commerce websites, where the MID is associated with the terminal or the website. The “Commerce window” has a dynamic MID concept where the MID is associated with the “Offer” or Offer ID, and not the terminal or the website. “Commerce window” brings an offer directly to the user/consumer with the payment built in. Instead of linking a user back to a merchant's website to complete the payment, the payment can be accepted with the offer and the payment is processed for the merchant by an intermediary service. The payment goes to the MID associated with the offer. In essence, every mobile phone or internet appliance becomes a dynamic POS terminal, and whoever presents the offer is accepting and receiving the payment, not who owns the POS terminal. Furthermore, once the payment is authorized, the right order is delivered to the merchant by the “commerce window” and the merchant is notified to “fulfill” this order. This is different than traditional e-commerce websites, which do not rely on a “commerce window” to authorize payment nor deliver order fulfillment requests. The presentation of the offer is done by a trusted 3^{rd} party or intermediary service (CWG) who assures the user that their merchant making the offer is legitimate, and not any random website or URL. If there is a chargeback, it is still the merchant's responsibility, but the consumer trusts the “commerce window” service provider, and has to “Opt-In” because it trust the merchant. With two known parties, it makes the mobile offers meaningful, relevant and trust worthy. Every merchant presenting the offer has a MID and merchant account, and a trusted third party (trusted intermediary service) is required to present such offers to their customers.

Applications

Imagine it is Monday night, and you have ordered from Dominos before, and have “opted in” to receive special offers from them. At 4:30 pm you receive an alert in the “commerce window” of your phone which says “Want to order Pizza for the Game Tonight? Special Offer from Dominos, 30% Discount, plus a free bottle of soda!” If you click “yes”, it takes you right into a menu to complete the order, and pay for delivery. To make it easier, “Same As Last Time” button to help you deliver the same order. Your payment instrument could be already stored, so you can simply enter a password to confirm the order and payment. The transaction is authorized, notification given to Dominos, email receipt is sent, and at the specified time, Pizza is delivered.

The next day, you receive another offer on your phone while going to work on the train, it says “From 1800Flowers, Valentine's day is next Tuesday, Order Now and save 20% plus free shipping.” You can click “yes” to take advantage of the offer. Same process takes place as described above. If birthdays and anniversaries are stored, reminders can be given on a timely basis, to provide you with more convenience. You can always decline or ignore the offers, or “Opt-Out” if you don't like the merchant anymore.

You are driving and listening to NPR on the radio, the local station is doing their annual fund raiser, you feel compelled to donate but it is not convenient to go home and log in, or call their 800 number and take out your credit card to pay. Instead you punch in a short code they provide (ex: 27771 via text,) that will tie the short code to an internal Offer ID and your cell phone number. Alternatively, you can call and tell an operator to send you the payment request to your mobile phone. A few seconds later the “commerce window” pops up and says “WBUR Thanks You for Your Generous Donation, To Complete the Donation Press Yes”—if you press yes, a menu pops up give you choice to select $25, $50, $100 or enter your own amount, pay with stored account, or enter a new Credit Card. Transaction is confirmed, receipt is emailed.

This can apply to any offer for goods and services. You could also be in front of a TV or seeing a billboard with an advertisement, again for you to have that offer delivered to your “commerce window” for you to buy, simply enter the short code to have the offer sent to you on your mobile to conveniently transact.

In another example, a merchant wants to present an offer for its customer with mobile phone number 781 555 1212. It knows the customer is running out of supplies of its nutrition products, and wants to send out an offer or alert to reorder for next month, and also has a special on a new product which is discounted by 25% if they order today. An offer is sent to the mobile phone where it wakes up an application and the “commerce window” where the offer is displayed to the user/consumer like an SMS or MMS. The user then can discard, or open the offer, and if they decide they want to buy, they simply click on “Buy” as part of the menu selection, and they can enter their own credit card information, can enter SKU, quantity, shipping information, if needed, or simply select “Secure FastPay” and the order will be executed, and transaction completed via the Merchant's MID. Additional authentication may be asked for by the merchant via the “commerce window” to make sure the offer and payment is in fact conducted by their customer. This can be in the form of a user name password, or a security token stored on the remote terminal (mobile phone etc.) like a NFC chip, or a secure ID. Card readers may be added to interface with the remote terminal like a card reader to ensure another level of authentication. The multiple ways of identifying the terminal from the cell phone number to unique identification of the terminal makes it more secure than a standard web browser. It also ensures a level of one-to-one marketing that is targeted properly to the end user/consumer, while maintaining a high level of security and trust in the system.

Among the advantages of this invention are one or more of the following. For merchants it means much better way to target and reach their customers and get repeat business and loyalty. Keeping customers is more profitable than finding new ones, and the “commerce window” application can also help attract new customers browsing the ROAM mall. For consumers it means convenience of reminders from merchants they know, convenience of payment with a trusted third party that secures payment information for the merchants, not having to dig out a payment card every time payment is needed, easier than going online or calling a 1800 number, or going to the physical store to buy something.

Several embodiments of the present invention have been described. Nevertheless, it will be understood that various modifications may be made without departing from the spirit and scope of the invention. Accordingly, other embodiments are within the scope of the following claims.

What is claimed is:

1. A commerce window system for merchants to deliver commerce functionalities to consumers computing devices without the consumer having to log into a merchant's website to complete purchasing transactions, said system comprising:
a consumer computing device comprising a commerce application player executable by said consumer computing device;
a commerce window gateway server comprising a commerce application and a secure payment application and wherein said commerce window gateway server communicates with said consumer computing device via a first network connection;
a plurality of merchants configured to provide product offers to said consumer computing device via said commerce application and to receive payments via said secure payment application;
wherein said commerce application comprises a plurality of commerce offer managers and wherein each commerce offer manager is associated with a specific merchant and comprises a commerce offer application that presents product offers for sale by said specific merchant;
wherein a specific commerce offer application of a specific merchant is downloaded and executed by said commerce application player in said consumer computing device and displays product offers from said specific merchant in said consumer computing device;
wherein each commerce offer manager further comprises an offer management application used to generate product offers by said specific merchant; and
wherein each product offer is associated with a product offer identifier and a specific merchant identifier.

2. The system of claim 1 wherein each of said product offers comprises a product description, price, shipping method and order parameters.

3. The system of claim 2 wherein each of said product offers further comprises collected demographic and marketing information.

4. The system of claim 1 wherein said product offer identifier comprises one of automatically generated ID, barcode reader generated ID, or Near Field Communication (NFC) tag.

5. The system of claim 1 wherein each commerce offer manager further comprises a marketing application used to respond to consumer requests for product offers by said specific merchant and to push product offers from said specific merchant to said consumer computing device and wherein said product offers are embedded into said commerce offer application.

6. The system of claim 5 wherein said consumer requests are placed via one of entering a product offer ID, tapping on a screen image, clicking a “buy-now” button, selecting from a browsing list, text messaging, e-mailing or phone calling.

7. The system of claim 5 wherein said product offers are pushed to said consumer computing device by said commerce offer manager via text messaging or messaging means utilizing an open socket that listens for push commands.

8. The system of claim 1 further comprising one or more additional consumer computing devices and wherein each additional consumer computing device comprises said commerce application player.

9. The system of claim 8 wherein each consumer computing device comprises a device identifier and wherein said each product offer is further associated with the device identifiers of the consumer computing devices that have elected to receive said product offer.

10. The system of claim 1 wherein said commerce application player is configured to download and execute a plurality of commerce offer applications displaying products offered by a plurality of merchants, respectively and wherein said plurality of merchants were previously selected by a user of said consumer computing device.

11. The system of claim 10 wherein said commerce window gateway server further comprises a first table comprising said association of each product offer with a product offer identifier, a specific merchant identifier, a device identifier and an affiliate third party identifier.

12. The system of claim 11 further comprising one or more payment processors, wherein said payment processors communicate with said secure payment application of said commerce window gateway server and process payments for the products offered for sale by said plurality of merchants.

13. The system of claim 12 wherein said commerce window gateway server further comprises a second table associating each of said specific merchant identifiers with said one or more payment processors.

14. The system of claim 13 wherein said secure payment application stores previously used payment instruments in user accounts associated with each consumer.

15. The system of claim 14 wherein each consumer accesses a user account via an authentication mechanism comprising one of providing a user name and password, voice authentication or biometric authentication.

16. The system of claim 14 wherein said secure payment application delivers payment information to a payment processor associated with a specific merchant wherein said payment information comprises payment instrument, payment amount and specific product purchased via said consumer computing device.

17. The system of claim 16 wherein said secure payment application further receives payment confirmation from said payment processor upon completion of payment and forwards said payment confirmation to the commerce offer manager of said specific merchant.

18. The system of claim 17 wherein each commerce offer manager further comprises a fulfillment application and wherein said fulfillment application processes order fulfillment and product shipping upon receipt of said payment confirmation.

19. The system of claim 1 wherein said consumer computing device comprises a managed code environment and wherein said commerce application player is executed within said managed code environment and wherein said managed code environment comprises one of Small Technical Interoperability Platform Virtual Machine (STIP VM), J2ME, .NET, or Flash Lite.

20. The system of claim 1 wherein said commerce application player comprises a rich and secure client application configured to display said product offers via text, graphics, video or audio.

21. The system of claim 1 wherein said commerce application player is configured to be woken up manually or automatically via text messaging or a TCP/IP socket listener.

22. The system of claim 1 wherein said commerce application player is dynamically downloaded to said consumer computing device via a link embedded in an advertisement of a product offer.

23. The system of claim 1 wherein said commerce application player is dynamically downloaded to said consumer computing device in response to a user's request for a specific product offer.

24. The system of claim 1 wherein said commerce application player is preloaded to said consumer computing device.

25. The system of claim 1 wherein said consumer computing device comprises one of mobile phone, PDA, payment module, portable computer, personal computer, set-top box, netbook, tablets, iPad, electronic reader or an internet appliance.

26. The system of claim 1 further comprising an advertising application, wherein said advertising application presents advertisements of product offers to said consumer computing device via said commerce offer application.

27. The system of claim 26 wherein said advertising application is comprised within said commerce window gateway server or within an affiliated third party API.

28. The system of claim 26 wherein said product advertisements comprise links to commerce offer applications of merchants providing said product offers.

29. The system of claim 1 wherein product offers of a specific merchant are requested by a user of said consumer computing device via said merchant's downloaded specific commerce offer application or via an affiliated third party application.

30. The system of claim 1 wherein said commerce application player further comprises a request for product offers application for pulling advertisements of products and product offers provided by said commerce offer managers and wherein said request for product offers application pulls advertisements of products and product offers via one of a product code, bar code, NFC tag, phone call, web request or text message.

31. The system of claim 1 wherein said commerce application player further comprises an account manager, security data and user authentication data.

32. A method for merchants to deliver commerce functionalities to consumers computing devices without the consumer having to log into a merchant's website to complete purchasing transactions, said method comprising:
providing a consumer computing device comprising a commerce application player executable by said consumer computing s device;
providing a commerce window gateway server comprising a commerce application and a secure payment application and wherein said commerce window gateway server communicates with said consumer computing device via a first network connection;
providing a plurality of merchants configured to provide product offers to said consumer computing device via said commerce application and to receive payments via said secure payment application;
wherein said commerce application comprises a plurality of commerce offer managers and wherein each commerce offer manager is associated with a specific merchant and comprises a commerce offer application that presents product offers for sale by said specific merchant;
wherein a specific commerce offer application of a specific merchant is downloaded and executed by said commerce application player in said consumer computing device and displays product offers from said specific merchant in said consumer computing device;
wherein each commerce offer manager further comprises an offer management application used to create product offers by said specific merchant; and
wherein each product offer is associated with a product offer identifier and a specific merchant identifier.

33. The method of claim 32 wherein each of said product offers comprises a product description, price, shipping method and order parameters.

34. The method of claim 33 wherein each of said product offers further comprises collected demographic and marketing information.

35. The method of claim 32 wherein said product offer identifier comprises one of automatically generated ID, barcode reader generated ID, or Near Field Communication (NFC) tag.

36. The method of claim 32 wherein each commerce offer manager further comprises a marketing application used to respond to consumer requests for product offers by said specific merchant and to push product offers from said specific merchant to said consumer computing device and wherein said product offers are embedded into said commerce offer application.

37. The method of claim 36 wherein said consumer requests are placed via one of entering a product offer ID, tapping on a screen image, clicking a “buy-now” button, selecting from a browsing list, text messaging, e-mailing or phone calling.

38. The method of claim 36 wherein said product offers are pushed to said consumer computing device by said commerce offer manager via text messaging or messaging means utilizing an open socket that listens for push commands.

39. The method of claim 32 further comprising one or more additional consumer computing devices and wherein each additional consumer computing device comprises said commerce application player.

40. The method of claim 39 wherein each consumer computing device comprises a device identifier and wherein said each product offer is further associated with the device identifiers of the consumer computing devices that have elected to receive said product offer.

41. The method of claim 32 wherein said commerce application player is configured to download and execute a plurality of commerce offer applications displaying products offered by a plurality of merchants, respectively and wherein said plurality of merchants were previously selected by a user of said consumer computing device.

42. The method of claim 41 wherein said commerce window gateway server further comprises a first table comprising said association of each product offer with a product offer identifier, a specific merchant identifier, a device identifier and an affiliate third party identifier.

43. The method of claim 42 further comprising one or more payment processors, wherein said payment processors communicate with said secure payment application of said commerce window gateway server and process payments for the products offered for sale by said plurality of merchants.

44. The method of claim 43 wherein said commerce window gateway server further comprises a second table associating each of said specific merchant identifiers with said one or more payment processors.

45. The method of claim 44 wherein said secure payment application stores previously used payment instruments in user accounts associated with each consumer.

46. The method of claim 45 wherein each consumer accesses a user account via an authentication mechanism comprising one of providing a user name and password, voice authentication or biometric authentication.

47. The method of claim 45 wherein said secure payment application delivers payment information to a payment processor associated with a specific merchant wherein said payment information comprises payment instrument, payment amount and specific product purchased via said consumer computing device.

48. The method of claim 47 wherein said secure payment application further receives payment confirmation from said payment processor upon completion of payment and forwards said payment confirmation to the commerce offer manager of said specific merchant.

49. The method of claim 48 wherein each commerce offer manager further comprises a fulfillment application and wherein said fulfillment application processes order fulfillment and product shipping upon receipt of said payment confirmation.

50. The method of claim 32 wherein said consumer computing device comprises a managed code environment and wherein said commerce application player is executed within said managed code environment and wherein said managed code environment comprises one of Small Technical Interoperability Platform Virtual Machine (STIP VM), J2ME, .NET, or Flash Lite.

51. The method of claim 32 wherein said commerce application player comprises a rich and secure client application configured to display said product offers via text, graphics, video or audio.

52. The method of claim 32 wherein said commerce application player is configured to be woken up manually or automatically via text messaging or a TCP/IP socket listener.

53. The method of claim 32 wherein said commerce application player is dynamically downloaded to said consumer computing device via a link embedded in an advertisement of a product offer.

54. The method of claim 32 wherein said commerce application player is dynamically downloaded to said consumer computing device in response to a user's request for a specific product offer.

55. The method of claim 32 wherein said commerce application player is preloaded to said consumer computing device.

56. The method of claim 32 wherein said consumer computing device comprises one of mobile phone, PDA, payment module, portable computer, personal computer, set-top box, netbook, tablets, iPad, electronic reader or an internet appliance.

57. The method of claim 32 further comprising an advertising application, wherein said advertising application presents advertisements of product offers to said consumer computing device via said commerce offer application.

58. The method of claim 57 wherein said advertising application is comprised within said commerce window gateway server or within an affiliated third party API.

59. The method of claim 57 wherein said product advertisements comprise links to commerce offer applications of merchants providing said product offers.

60. The method of claim 32 wherein product offers of a specific merchant are requested by a user of said consumer computing device via said merchant's downloaded specific commerce offer application or via an affiliated third party application.

61. The method of claim 32 wherein said commerce application player further comprises a request for product offers application for pulling advertisements of products and product offers provided by said commerce offer managers and wherein said request for product offers application pulls advertisements of products and product offers via one of a product code, bar code, NFC tag, phone call, web request or text message.

62. The method of claim 32 wherein said commerce application player further comprises an account manager, security data and user authentication data.

63. A method for merchants to deliver commerce functionalities to consumers computing devices without the consumer having to log into a merchant's website to complete purchasing transactions, said method comprising:
providing a consumer computing device;
providing a commerce window gateway server comprising a commerce application;
registering a plurality of merchants into said commerce application and for each merchant generating a commerce offer manager with said commerce application, wherein said commerce offer manager comprises a commerce offer application configured to provide product offers from said merchant to said consumer computing device via said commerce window gateway server;
signing-up a user of said consumer computing device to purchase products offered by said merchant via said commerce offer application;
downloading and installing a commerce application player into said consumer computing device,
downloading and executing said commerce offer application of said merchant in said consumer computing device with said commerce application player and displaying product offers from said specific merchant in said consumer computing s device;
wherein each product offer is associated with a product offer identifier and a specific merchant identifier;
wherein said commerce window gateway server further comprises a payment application and wherein said payment application stores previously used payment instruments in user accounts associated with each consumer computing device; and
delivering payment information by said payment application to a payment processor associated with a specific merchant and wherein said payment information comprises payment instrument, payment amount and specific product purchased via said consumer computing device.
